(19) United States
(12) Patent Application Publication
(10) Pub. No.: US 2006/0127542 A1
(43) Pub. Date: Jun. 15, 2006

(54) Absorbent popsicle holder

(76) Inventors: David Wachtel, Dallas, TX (US); Kathy Wachtel, Dallas, TX (US)

Correspondence Address: Scott L. Harper;Carstens & Cahoon LLP, PO Box 802334, Dallas, TX, 75380, US

(21) Appl. No.: 11/015,314

(22) Filed: Dec. 15, 2004

(51) Int. Cl. A23L 1/00

(52) U.S. Cl. 426/134

(57) ABSTRACT

The invention relates to a drip absorber for frozen treats on a stick. The drip absorber is manufactured into various desired shapes from compressed cellulose sponge material with a pre-punched hole for the frozen treat stick to be inserted into. The absorber is positioned at the base of a frozen confection which includes a stick for holding the treat. The absorber will enable the user to enjoy the frozen treat without troublesome, sticky drippings falling on their hands, arms or clothing. After the treat is finished, the absorber can be thrown away, rinsed with water or cycled through a dishwasher and used again with subsequent frozen treats.

### BACKGROUND OF THE INVENTION

1. Technical Field

The invention relates to an absorbing holder for frozen treats on a stick. The frozen treat holder is an absorbent compressed cellulose sponge with a pre-punched hole for the frozen treat stick to be inserted into.

2. Description of Related Art

The popsicle was invented in 1905. The patent for frozen ice on a stick was received in 1924. The industry sells more than a billion of the various flavored ice on a stick treats every year. Frozen treats or stick treats include popsicles, ice creams and other confections which utilize a wooden or plastic stick on which the treat is positioned which allows the user to easily manipulate the treat for consumption. An inherent problem with consuming a frozen treat on a stick is that during consumption the treat begins to thaw. As the product thaws, drippings from the treat travel down the stick to the hands and clothing of the consumer. This leads to sticky, messy hands, face and clothing of the frozen treat eater.

Several attempts have been made to try and remedy the problem of drippings from the frozen treat making the consumer's hands, face and clothing sticky. For instance, U.S. Pat. No. 5,770,250(Smith) describes a folded polyester device for absorbing frozen treat meltings and for pushing up the frozen treat as it is consumed. U.S. Pat. No. 2,948,452 (Grogan et al.) describes a molded plastic device designed to hold an ice cream cone and catch melted materials. U.S. Pat. No. 2,803,550(Ackalusky) discloses a guard device for frozen confections comprising a panel having an upwardly-extending perimetrical wall and a slit located in the center thereof. A rectangular block of sponge rubber is mounted to the panel. The block has a slit which is aligned with the slit in the panel so as to receive a stick of a frozen confection. The block absorbs melted liquid from the confection which attempts to leak between the stick and the slit in the panel. The upstanding walls and panel accumulate liquid that runs off the frozen treat which can later be discarded.

However, the prior art devices do not adequately and easily accomplish efforts to keep the consumer of the frozen treat from coming into contact with drippings. The prior art solutions discussed above typically result in cumbersome treat holders made of paper, plastic or polyester which are not easily installed, managed or removed after consumption of the treat. Prior art paper holders can tear easily and do not have adequate absorption characteristics to handle various volumes of drippings. Plastic holders do not absorb or retain drippings; therefore, the drippings can accumulate and if not handled properly can spill onto the consumer. Similarly, the polyester devices are cumbersome for the average consumer to use, they are not biodegradable or environmentally safe, and there is the potential of the polyester not absorbing all of the drippings which could result in run off onto the consumer's hands and clothing. Moreover, the polyester holder contains several layers and has to be originally sewn and assembled in order to function which lends itself to an expensive and difficult manufacturing process. Typically, some of the prior art solutions require cumbersome reassembly by the consumer for it reuse. Paper and polyester holders could potentially burn or combust if exposed to a flame. Plastic holders could potentially melt if placed in a household dishwasher for cleaning.

As such, there exists a need in the art for a simple, easy to use frozen treat drip retention device that is easy for both adults and children to use and reuse, which is biodegradable, non-toxic and non-flammable.

### SUMMARY OF THE INVENTION

The invention disclosed herein consists of a preformed, compressed cellulose material with a pre-punched slot for absorbing drippings from a frozen treat. The drip absorber can be manufactured in a variety of colors and shapes and can contain images and/or advertisement display with non-toxic inks. The drip absorber is positioned on the stick of the frozen treat between the frozen treat and the hand of the consumer. The compressed cellulose is “sponge-like” and unique in that there is “component memory” and absorber expands as necessary to absorb the volume of drippings. Said expansion is limited to the contact location and the volume of drippings absorbed by the drip absorber. As a result, the drip absorber expands and absorbs from the slot outwards as drippings accumulate thus keeping the hands and clothing clean and the consumer entertained by watching the expansion of the drip absorber in action. If not recycled or thrown away, subsequent uses of the invention can be utilized in the uncompressed form or while still moist, then reasonably recompressed under a flat heavy object into a semi-compressed dry state.

Additionally, the invention can serve additional purposes. Once fully expanded and dried, the invention can be used as a toy (e.g. pool Frisbee), it can clean up other spills such as a drink or juice and can be used with liquid soap/water to wash the consumers hands as well as other dishes/utensils. Many other features, objects and advantages of the present invention will be apparent to those of ordinary skill in the relevant arts, especially in light of the foregoing discussions and the following drawings, detailed description and appended claims.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings wherein: The invention will now be described with reference to the drawings in which:

FIG. 1 is the drip absorber as shown on a frozen treat stick;

FIG. 2A is a plan view of the drip absorber as disclosed herein; and,

FIG. 2B is a perspective view of the drip absorber disclosed herein.

### DETAILED DESCRIPTION OF THE INVENTION

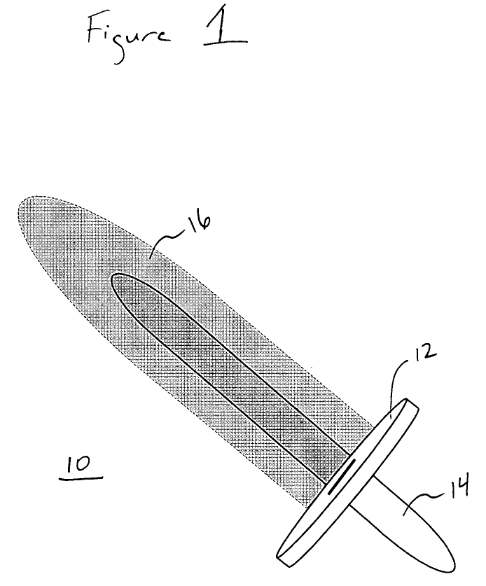

FIG. 1 illustrates the preferred embodiment of the invention disclosed herein as shown in actual use 10. The drip absorber 12 is shown positioned on the stick 14 on which a frozen treat 16 is secured. As the treat 16 is consumed, the drippings caused by melting are absorbed by the drip absorber 12 thereby preventing drippings from contacting stick 14 and the hands of the consumer. The drip absorber 12 expands as necessary to absorb the volume of drippings accumulated thereon. After the consumer is finished with the treat, he or she may remove the drip absorber 12 from the stick 14 for rinsing and reuse via hand-wash or a conventional dishwasher. The consumer may also reuse the drip absorber 12 as a toy for children or for household cleaning where a sponge is commonly used. The consumer may safely dispose of the drip absorber 12 in standard refuse collection devices for burial in a landfill, as the drip absorber is constructed of non-toxic, biodegradable material.

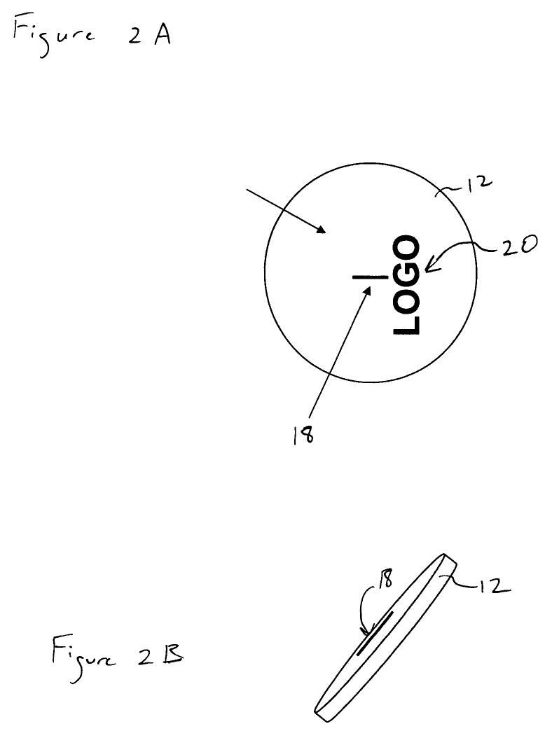

FIG. 2A is a plan view of the drip absorber device disclosed herein shown in a pre-formed circular embodiment. The drip absorber 12 is constructed of dried, compressed cellulose. In the preferred embodiment, the drip absorber is compressed to 0.5 to 1 mm in height. The drip absorber is typically pre-formed, in the circular embodiment, to a diameter of roughly 70 mm. A slot 18 is then formed in the center of the drip absorber with a cutting or die-stamping device. Slot 18 is roughly 12 to 13 mm in length. As drippings are absorbed, the dimensions of the drip absorber will increase due to the absorption of drippings. Typically, the diameter of the drip absorber will increase by 6 to 7 mm and the height will increase by 2 to 10 mm. FIG. 2A also demonstrates the possible placement of a trademark, logo, or advertisement 20 which may be imprinted on the drip absorber with non-toxic inks. FIG. 2B is a perspective view of the drip absorber 12 shown with pre-cut slot 18.

Although the present invention has been described in terms of an exemplary embodiment, it is not limited to these embodiments and modifications. Alternative embodiments, modifications, and equivalents, which would still be encompassed by the invention, may be made by those of ordinary skill in the art, in light of the foregoing teachings. Therefore, the following claims are intended to cover any alternative embodiments, modifications, or equivalents which may be included within the spirit and scope of the invention defined by the claims.

1. A drip absorber for a frozen treat comprising:
a pre-formed shape consisting of dried, compressed biodegradable cellulose material;
a pre-cut slot located in the pre-formed shape through which the exposed end of a stick protruding from a frozen treat is inserted and the preformed shape is brought into contact with the frozen treat; and,
wherein liquid drippings from the frozen treat are absorbed by the compressed cellulose material in proportion to the drippings which contact the compressed cellulose material.

2. The absorber of claim 1 wherein the pre-formed shape is one of a circle, rectangle, trapezoid, pentagon, hexagon, heptagon, octagon, polygon, square, starburst or other die-stamped shape.

3. The absorber of claim 1 wherein a logo is imprinted upon a surface of the pre-formed shape.

4. The absorber of claim 1 wherein the absorber expands proportionally in height as the liquid drippings are absorbed.

5. The absorber of claim 1 wherein the absorber expands proportionally in diameter as the liquid drippings are absorbed.

6. (canceled)

7. (canceled)

8. The absorber of claim 1 wherein the absorber is capable of being cycled through a dishwasher for reuse.
